(19) United States
(12) Patent Application Publication
(10) Pub. No.: US 2012/0255218 A1
(43) Pub. Date: Oct. 11, 2012

(54) TIPPET DISPENSER

(76) Inventor: Andrew B. Haroian, Boise, ID (US)

(21) Appl. No.: 13/084,334

(22) Filed: Apr. 11, 2011

(51) Int. Cl. A01K 97/00; B65H 75/18; B29C 55/00; B65H 75/30

(52) U.S. Cl. 43/54.1; 425/383; 425/289

(57) ABSTRACT

A line storage and dispensing device having a spool housing and line passage. The line passage is configured so that friction is created between the line and the line channel. The friction is great enough to resist casual advance of the line through the line channel, substantially maintaining the angular position of the spool in the housing, reducing line unspooling, accidental retraction of the line into the housing or backlash of the line on the spool. The line passage is formed preferably in a resilient material that allows a compressive force to be selectively and manually applied against the line passage and the line. The compressive force is of a magnitude great enough to allow the line to be tensioned as it is pulled from the spool through the line passage, straightening the line and removing coil memory in the line as it is withdrawn from the spool.

### BACKGROUND OF THE INVENTION

1. Field of the Invention

This invention relates to line dispensing devices, and more particularly to a device for storing and dispensing line for attachment to a fishing line.

2. Background

Fly fishing is a method of sport fishing for any of a variety of fish species including trout and salmon. A fish is caught by using an artificial fly attached at or near the end of a line which is cast using a fly rod. The fly line is typically weighted along its full length to promote the ability of the angler to cast. A leader section is typically attached to the end of the fly line and the artificial fly is then attached to a distal end of the leader referred to as a tippet.

A number of factors may influence the choice of diameter for the tippet section of the leader, including the size of fly that is to be attached to the line, the species and size of fish that are known generally to be present in a particular body of water and the relative turbulence and turbidity of that body of water. Due to the fact that the tippet is subject to abuse and failure it is not uncommon for the angler to add to the tippet from time to time while fishing. As such it is imperative that an angler carry with him at all times, replacement tippet line that may be cut to length as needed and added by knotting to the leader. Because of the number of variables that the angler must consider in making a choice of tippet diameter, it is prudent for the angler to carry several separate spools each containing tippet material of a specific diameter. Since tippet spools tend to run of a generally similar size, particularly if marketed by the same manufacturer, it can become difficult at times for the angler to locate the desired tippet material, a task that typically involves fumbling through a number of spools typically stashed in one of several pockets.

Once the tippet is located, a desired length is pulled from the spool and cut. The spool is place back among the pockets and the tippet is fixed to the end of the leader. It is common for tippet line that has been pulled from a spool to retain or exhibit “coil memory” from its life wound about the spool that must be eliminated before the artificial fly can be attached and cast. Once again, most anglers carry some device utilized for the purpose of straightening the leader and tippet. One common version of this device comprises a pair of leather flaps that the line may be pinched between and then drawn through, applying tension to the line. The pair of flaps may be attached to the angler's vest or a lanyard.

Attempts have been made at resolving these issues for the angler. Housings that enclose multiple spools with a free end of the line projecting through a sidewall of the housing have been developed. See for example, U.S. Pat. No. 6,694,667 to Davis, U.S. Pat. No. 4,141,479 to Dennison, U.S. Pat. No. 4,026,063 to Allen, et al., U.S. Pat. No. 3,612,427 to Bishop, et al. and U.S. Pat. No. 2,517,866 to Glahn. Several devices have been developed that include housings that enclose at least one spool of fishing line and include means for minimizing unwanted unspooling of the line. See for example, U.S. Pat. No. 4,026,063 to Allen, et al., and U.S. Pat. No. 3,612,427 to Bishop, et al. Others devices have been developed that include housings for enclosing one or more fishing line spools that also include a cutter for cutting a desired length of line. See for example, U.S. Pat. No. 6,694,667 to Davis, U.S. Pat. No. 4,290,223 to Ostenberg, et al., and U.S. Pat. No. 4,141,479 to Dennison. Housings that enclose a plurality of fishing line spools have also been developed that include a line straightening or de-coiling element. See for example, U.S. Pat. No. 5,738,297 to Bailey, et al., U.S. Pat. No. 4,290,223 to Ostenberg, et al., and U.S. Pat. No. 3,612,427 to Bishop, et al.

The prior art does not disclose a fishing line storage and dispensing device that is configured to hold and store one, two or more interchangeable spools of fishing line, wherein the line storage and dispensing device includes a line passage configured so that line may be passed from the spool through the line passage in such a manner that allows a position of the spool and the line from that spool to be substantially maintained against unspooling, accidental refraction into the housing or backlash, and wherein the line passage is also configured so that a compressive force may be selectively applied against the line passage and the line, the compressive force adequate to allow the line to be tensioned to an extent that the line is straightened, removing the coil memory in the line as it is withdrawn from the spool.

There is a need for a fishing line storage and dispensing device that includes a line passage configured so that a line may be passed from the spool through the line passage in such a manner that allows a position of the spool and the line from that spool to be substantially maintained against unspooling, accidental retraction into the housing or backlash, unless and until a tensive force is applied to the line to overcome a resistance of the line against the line passage, wherein the line passage is also configured so that a compressive force may be selectively applied against the line passage and the line, the compressive force adequate to allow the line to be tensioned to an extent that the line is straightened, removing the coil memory in the line as it is withdrawn from the spool. There is also a need for such a fishing line storage and dispensing device that includes one or more removable and interchangeable spools. Additionally, there is a need for such a fishing line storage and dispensing device that includes means for cutting a length of line from the spool incorporated into the spool housing, wherein the cutter is positioned such that the line is cut in a manner that assures that a length of line will remain extending from the housing after the line is severed.

Therefore, one object of the present invention is to provide a fishing line storage and dispensing device configured so that a line may be passed from the spool through the line passage in such a manner that allows a position of the spool and the line from that spool to be substantially maintained against unspooling, accidental refraction into the housing or backlash. Another object of the present invention is to provide a fishing line storage and dispensing device having a line passage that is configured so that a compressive force may be selectively and manually applied against the line passage and the line, the compressive force adequate to allow the line to be tensioned to an extent that the line is straightened, in order to remove the coil memory in the line as it is withdrawn from the spool. Another object of the present invention is to provide a fishing line storage and dispensing device as described above that also includes one or more removable and interchangeable spools. Another object of the present invention is to provide a fishing line storage and dispensing device as described above that includes means for cutting a length of line from the spool incorporated into the spool housing, wherein the cutter is positioned such that the line is cut in a manner that assures that a length of line will remain extending from the housing after the line is severed.

### SUMMARY OF THE INVENTION

The present invention is directed to a line storage and dispensing device including a spool housing configured so that line may be passed from the spool through the line passage in such a manner that allows a position of the spool and the line from that spool to be substantially maintained against unspooling, accidental retraction into the housing or backlash. The present invention is also directed to a line storage and dispensing device having a line passage configured so that a compressive force may be selectively and manually applied against the line passage and the line, the compressive force adequate to allow the line to be tensioned as it is pulled from the spool through the line passage so the line is straightened removing coil memory in the line as it is withdrawn from the spool. In a preferred embodiment of the invention the line storage and dispensing device includes a plurality of removable and interchangeable spools. Also in a preferred embodiment of the invention the line storage and dispensing device includes means for cutting a length of line from the spool.

### DESCRIPTION OF THE DRAWINGS

FIG. 1 is a representative perspective view of a line storage and dispensing device according to the present invention;

FIG. 2 is a representative perspective view of a line storage and dispensing device according to the present invention;

FIG. 3 is an exploded representative perspective view of a line storage and dispensing device according to the present invention;

FIG. 4 is a representative perspective view of a lower housing portion of a line storage and dispensing device according to the present invention;

FIG. 5 is a representative perspective view of an upper housing portion of a line storage and dispensing device according to the present invention;

FIG. 6 is a representative perspective view of a passage insert for a storage and dispensing device according to the present invention;

FIG. 7 is a representative top view of a passage insert and spool of a line storage and dispensing device according to the present invention;

FIG. 8 is a representative top view of a passage insert and spool of a line storage and dispensing device according to the present invention;

FIG. 9 is a representative perspective view of a spool of a line storage and dispensing device according to the present invention;

FIG. 10 is a representative cutaway view of a spool and a line storage and dispensing device according to the present invention; and

FIG. 11 is a representative perspective view of a cutter cover for a line storage and dispensing device according to the present invention.

### DETAILED DESCRIPTION

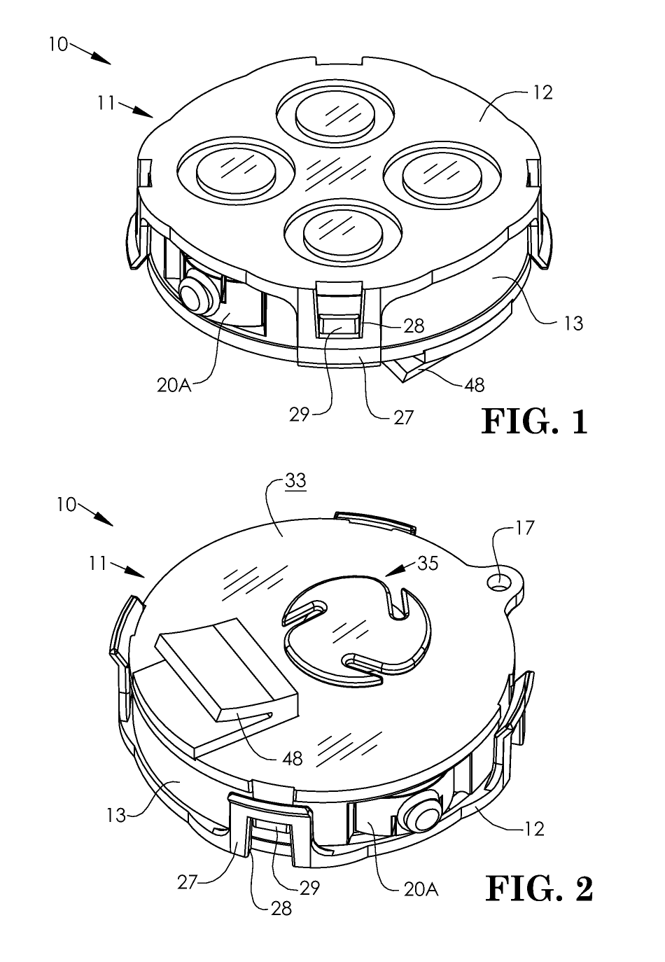

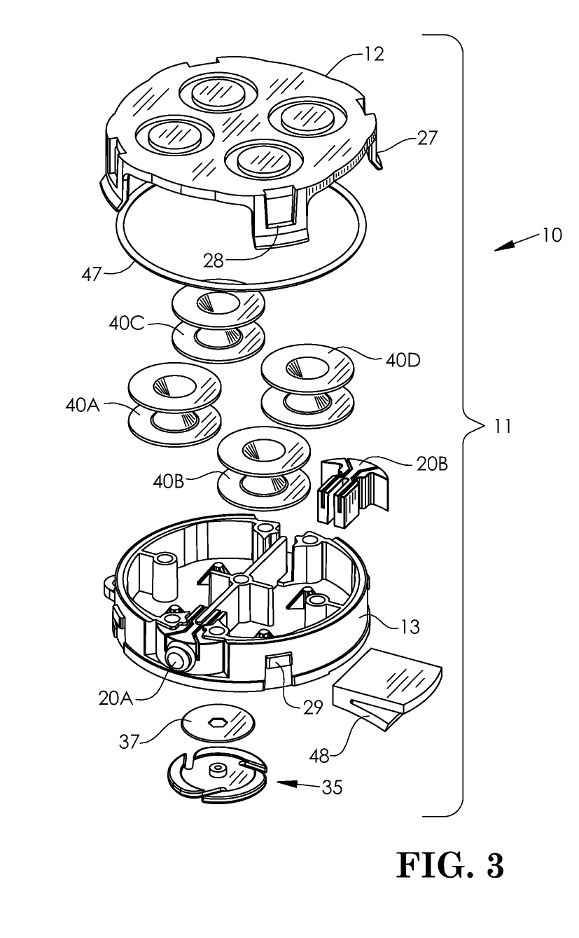

Referring to FIGS. 1 through 3, in a preferred embodiment of the invention, line storage and dispensing device 10 includes a two piece housing 11 including upper housing portion 12 configured to cooperatively engage with lower housing portion 13. Upper housing portion 12 is selectively separable from lower housing portion 13. Upper housing portion 12 includes a plurality of tangs 27 each including an aperture 28 through which a lobe 29 located on lower housing portion 13 fits to secure upper housing portion 12 to lower housing portion 13. FIG. 2 shows line cutter assembly 35 fixed to bottom surface 33 of lower housing portion 13. O-ring 48 is shown in FIG. 3 is disposed between upper housing portion 12 to lower housing portion 13 which are preferably fit together in such a manner as to provide a watertight seal. Attachment aperture 17 provides an attachment point or a lanyard, ring or the like.

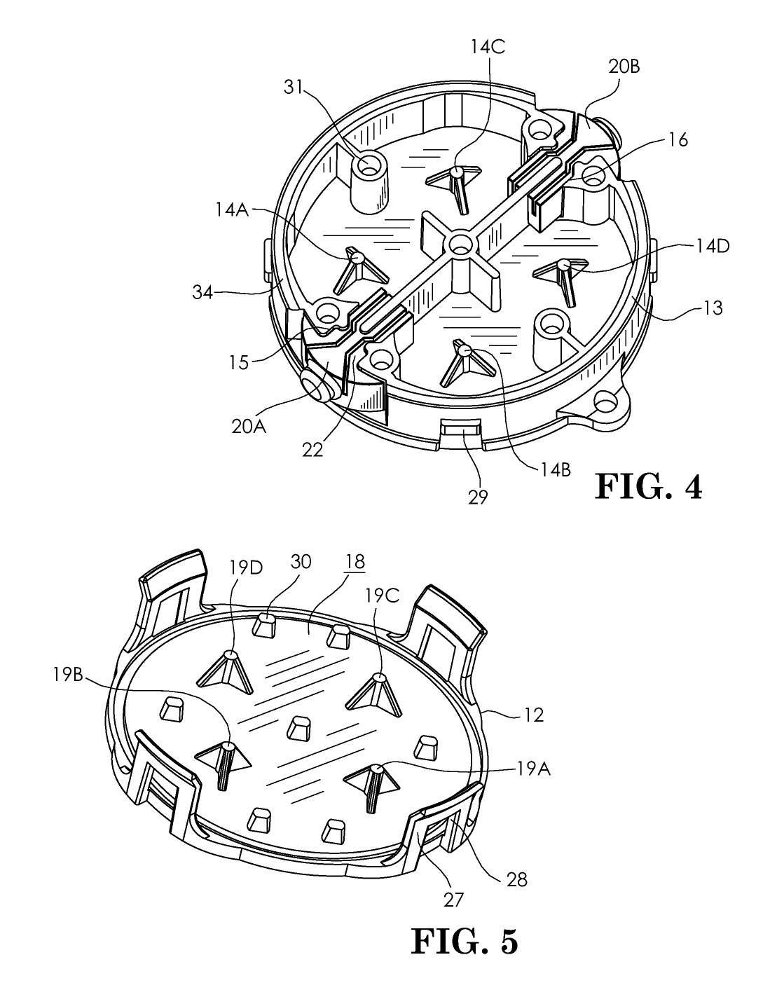

Referring to FIG. 3, spools 40A through 40D are positioned within housing 11. Either or both upper housing portion 12 and/or lower housing portion 13 are configured to include structure adapted to hold spools 40A through 40D in a selected position within housing 11. Referring to FIG. 4, lower housing portion includes lower spindle portions 14A, 14B, 14C and 14D. One of the four spools 40A through 40D (shown in FIG. 3), is positionable over and rotatable on one of the four lower spindle portions 14A, 14B, 14C or 14D. FIG. 5 shows corresponding spool locating structure formed on inside surface 18 of upper housing portion 12. Specifically, each of four upper spindle portions 19A, 19B, 19C and 19D, are, when upper housing portion 12 is engaged with lower housing portion 13, (as shown in FIGS. 1 and 2), positioned coaxially with lower spindle portions 14A, 14B, 14C and 14D respectively, (shown in FIG. 4). FIG. 5 also shows a plurality of locator pins 30 that correspond with and insert into locator apertures 31 formed in lower housing portion 13, (shown in FIG. 4) to properly position upper housing portion 12 with respect to lower housing portion 13.

Referring to FIGS. 3 and 4, lower housing portion 13 includes channels 15 and 16 formed in side wall 34. As shown in FIG. 4, passage insert 20A, which is typical of passage insert 20B, includes neck 22 that cooperates with one or more lobes 23, which at least partially defines channel 15, (channel 15 being typical of channel 16), that such that passage insert 20A is removably and snugly fitted in channel 15. In the preferred embodiment, passage inserts 20A and 20B are formed in such a manner as to provide a watertight fit between the passage inserts 20A and 20B and its respective channel channel 15 or 16.

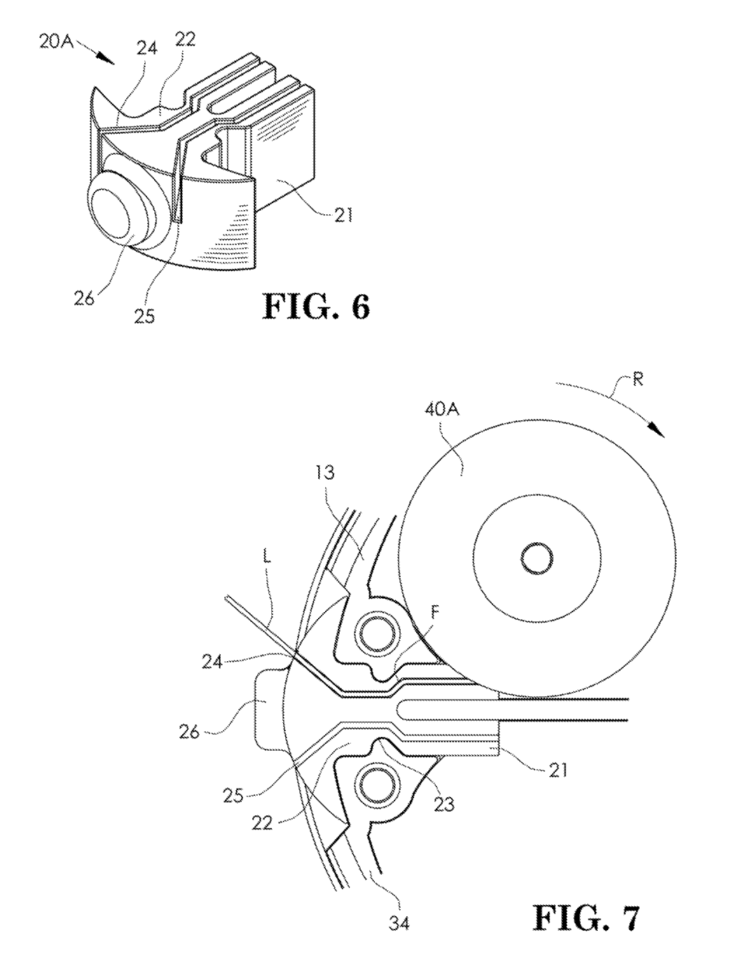

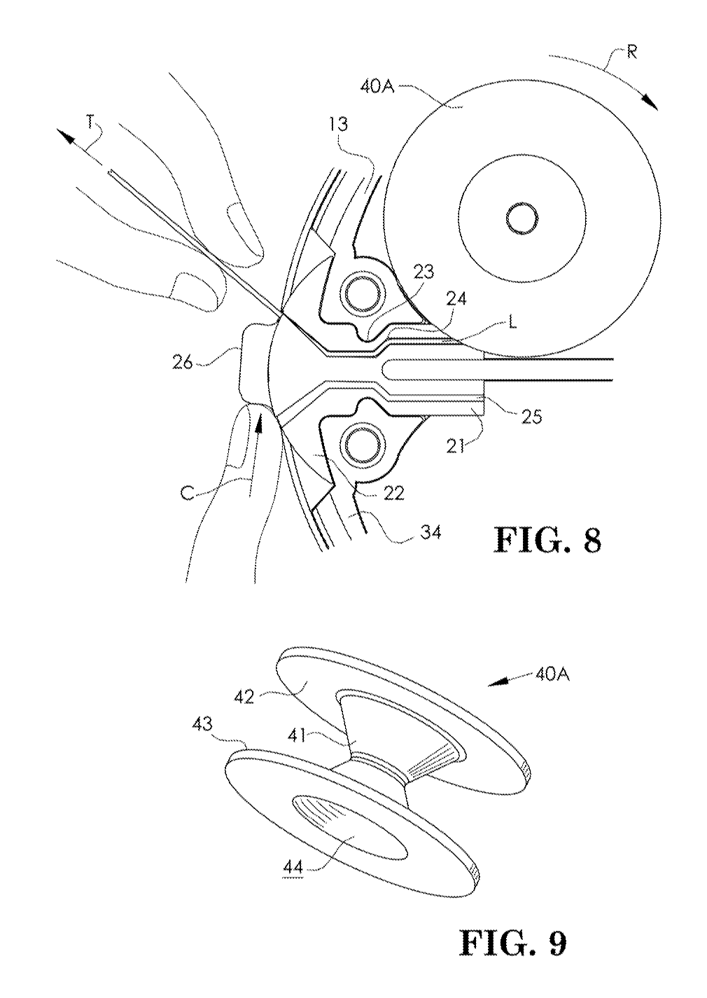

Referring to FIGS. 6 through 8, passage insert 20A is shown including body portion 21 having a pair of line passages 24 and 25 formed therein. In the preferred embodiment, line passages 24 and 25 are formed such that the resilient material that forms the sidewalls of the line passage close against each other and the line in such a manner as to provide at least a substantially watertight seal. Referring to FIGS. 7 and 8, passage inserts 20A and 20B are located in channels 15 and 16 formed in side wall 34 of lower housing portion 13. Passage inserts 20A and 20B are formed preferably of a resilient material that permits compression of the passage insert 20A or 20B and therefore the line passage 24 or 25 respectively against a line L passing there through. Line L from spool 40A is shown passing through line passage 24. Friction F between line L and line passage 24 is sufficient to substantially resist radial motion R of spool 40A, preventing unwanted un-spooling of the line from spool 40A. Friction F between line L and line passages 24 is created by providing a line passage 24 or 25 that is only slightly larger in width that the diameter of the line, by forming the passage insert from a material having a relative high coefficient of friction, for instance rubber or select polymers, and by forming the line passage so that it is non-linear, curved, convoluted or serpentine thereby increasing surface contact between the line and the line passage. Friction F between line L and line passages 24 is overcome when tensile force T is applied to line L by a user as line L is manually extracted from spool 40A.

Passage insert 20A is also configured having pressure application pad 26 against which, as shown in FIG. 8, a compressive force C may be selectively and manually applied, the compressive force C being applied simultaneously against line passage 24 and therefore against line L, the compressive force C adequate to allow the line to be tensioned as it is pulled from spool 40A through line passage 24 so line L is straightened removing coil memory in line L as it is withdrawn from spool 40A.

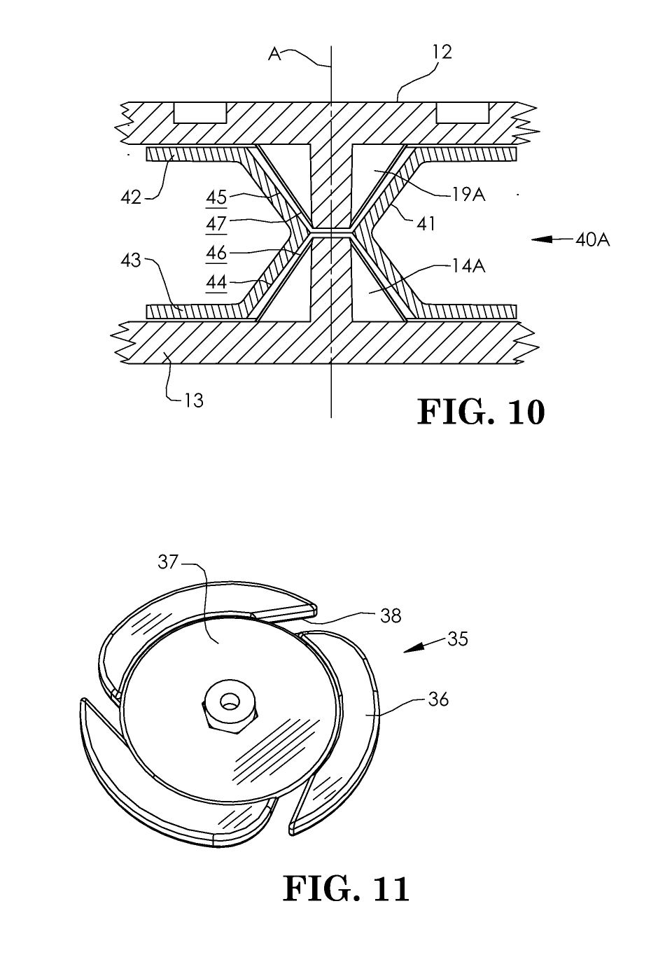

Spool 40A is shown in FIGS. 9 and 10. Spool 40A is configured having hub 41 connecting flanges 42 and 43. Hub 41 includes bearing surfaces 44 and 45. Line may be wrapped about the exterior surface of hub 41. In the preferred embodiment, hub 41 is configured so as to be positionable with respect to and rotatable about a spindle having a corresponding configuration. Preferably, a fit between the upper spindle portions 19A through 19D, (shown in FIG. 5), the lower spindle portions 14A through 14D, (shown in FIG. 4), and the configuration of an interior surface 44 of hub 41 of the four spools 40A through 40D, (shown in FIG. 3), respectively, is such that movement or migration, other than rotational motion of a particular spool 40A through 40D with respect its respective spindle portions 14A and 19A, 14B and 19B, 14C and 19C and 14D and 19D, within housing 11 is minimized. In the preferred embodiment, lower spindle portions 14A through 14D include bearing surfaces 46 that lie on a plane that is non-parallel or angular to the axis of rotation A of spool 40A. Similarly, upper spindle portions 19A-19D include bearing surfaces 47 that lie on a plane that is non-parallel or angular to the axis of rotation A of spool 40A. Bearing surfaces 44 and 45 of hub 41 rotate against the angular bearing surfaces 46 and 47 of upper and lower spindle portions respectively creating more friction between spool and spindle than that created by a spool that rotates freely about a spindle. The additional friction of the present arrangement helps in maintaining a position of the spool and line against unspooling, accidental refraction into the housing or backlash.

FIG. 11 depicts line cutter assembly 35, also shown in FIGS. 2 and 3. Line cutter assembly 35 includes cutter body 36 which is adapted to hold blade 37. Cutter body 36 is fixable to lower body portion 13, as seem in FIG. 2. Referring again to FIG. 11, cutter body 36 is configured having at least one line snare 38, against which a line, (not shown), may be drawn, pulling the line against blade 37 to sever the line. AS seen in FIG. 2, cutter assembly 35 is positioned with respect and attached to housing 11 such that line, (not shown in FIG. 2), is cut in a manner that assures that a length will remain extending from housing 11 after the line is severed.

While the preferred embodiment described and shown herein is adapted to store and dispense tippet for fly fishing applications, it is to be understood that the invention as claimed has broader applications in sport and commercial fishing and may be adapted to accommodate spools of various sizes, holding lines having a range of diameters.

The foregoing description of the illustrated embodiments has been presented for purposes of illustration and description. It is not intended to be exhaustive or to limit the invention to the precise form or to exemplary embodiment(s) and implementation(s) disclosed. Numerous modifications and variations will be apparent to practitioners skilled in this art. Elements described might be interchangeable with other elements in order to achieve the same result. At least one preferred embodiment was chosen and described in order to best explain the principles of the invention and a best mode of practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph unless the element is expressly recited using the phrase “means for . . . .”

What is claimed is:

1. A line storage and dispensing device comprising:
a spool housing;
at least one spool positioned in the spool housing; and
a line passage located in a wall of the spool housing, the line passage configured to permit dispensing of the line from the at least one spool, the line passage configured to apply friction against the line in the line passage; and
a pressure application pad operatively attached to the spool housing adjacent to the line passage, the pressure application pad adapted to permit a compressive force to be selectively and manually applied against the line from the spool, the compressive force adequate to allow the line to be tensioned as it is pulled from the spool through the line passage straightening the line.

2. The line storage and dispensing device of claim 1 further comprising an insert, the insert positionable in the wall of the spool housing, the line passage formed in the insert.

3. The line storage and dispensing device of claim 1 further comprising a resilient insert, the resilient insert positionable in the wall of the spool housing, the line passage formed in the resilient insert.

4. The line storage and dispensing device of claim 1 wherein the line passage further comprises a line passage configuration selected from a group of line passage configurations including a non-linear line passage, a serpentine line passage, an arcuate passage and a convoluted passage.

5. The line storage and dispensing device of claim 1 wherein the spool housing further comprises a spindle attached within the spool housing, the at least one spool positioned in the spool housing rotatable on the spindle.

6. The line storage and dispensing device of claim 1 wherein the wherein the spool housing further comprises a spindle portion attached within the spool housing, the spindle portion including a spool bearing surface that lies at an angle to an axis of rotation of the at least one spool positioned in the spool housing.

7. The line storage and dispensing device of claim 1 further comprising means for cutting a length of line from the spool connected to the spool housing.

8. The line storage and dispensing device of claim 2 wherein the line passage further comprises a line passage configuration selected from a group of line passage configurations including a non-linear line passage, a serpentine line passage, an arcuate passage and a convoluted passage.

9. The line storage and dispensing device of claim 2 wherein the insert further comprises a pressure application pad adapted to permit a compressive force to be selectively and manually applied against the line from one of the plurality of spools, the compressive force adequate to allow the line to be tensioned as it is pulled from the spool through the line passage straightening the line.

10. The line storage and dispensing device of claim 2 wherein the spool housing further comprises a spindle attached within the spool housing, the at least one spool positioned in the spool housing rotatable on the spindle.

11. The line storage and dispensing device of claim 2 wherein the spool housing further comprises a spindle portion attached within the spool housing, the spindle portion including a spool bearing surface that lies at an angle to an axis of rotation of the at least one spool positioned in the spool housing.

12. The line storage and dispensing device of claim 2 further comprising means for cutting a length of line from the spool connected to the spool housing.

13. The line storage and dispensing device of claim 3 wherein the line passage further comprises a line passage configuration selected from a group of line passage configurations including a non-linear line passage, a serpentine line passage, an arcuate passage and a convoluted passage.

14. The line storage and dispensing device of claim 3 wherein the resilient insert further comprises a pressure application pad adapted to permit a compressive force to be selectively and manually applied against the line from one of the plurality of spools, the compressive force adequate to allow the line to be tensioned as it is pulled from the spool through the line passage straightening the line.

15. The line storage and dispensing device of claim 3 wherein the spool housing further comprises a spindle attached within the spool housing, the at least one spool positioned in the spool housing rotatable on the spindle.

16. The line storage and dispensing device of claim 3 wherein the spool housing further comprises a spindle portion attached within the spool housing, the spindle portion including a spool bearing surface that lies at an angle to an axis of rotation of the at least one spool positioned in the spool housing.

17. The line storage and dispensing device of claim 3 further comprising means for cutting a length of line from the spool connected to the spool housing.

18. A tippet dispenser comprising:
a spool housing;
a plurality of spindles attached within the spool housing;
a plurality of spools positioned in the spool housing, each of the plurality of spools rotatable on one of the plurality of spindles;
a resilient insert removably fixed in a passage formed in a wall of the spool housing;
a plurality of line passages formed in the resilient insert, each of the plurality of line passages configured to permit dispensing of a line from one of the plurality of spools, each of the plurality of line passages further configured to apply friction against the line in the line passage;
the resilient insert including a pressure application pad adapted to permit a compressive force to be selectively and manually applied against the line from one of the plurality of spools, the compressive force adequate to allow the line to be tensioned as it is pulled from the spool through the line passage straightening the line; and
means for cutting a length of line from one of the plurality of spools connected to the spool housing.

19. The tippet dispenser of claim 18 wherein the line passage further comprises a line passage configuration selected from a group of line passage configurations including a non-linear line passage, a serpentine line passage, an arcuate passage and a convoluted passage.

20. The line storage and dispensing device of claim 18 wherein the spool housing further comprises a spindle portion attached within the spool housing, the spindle portion including a spool bearing surface that lies at an angle to an axis of rotation of the at least one spool positioned in the spool housing.
